(19) United States
(12) Patent Application Publication
(10) Pub. No.: US 2025/0177085 A1
(43) Pub. Date: Jun. 5, 2025

(54) FOOT CONTROLLER FOR DENTAL UNIT CHAIR AND DENTAL UNIT CHAIR COMPRISING SAME

(71) Applicant: OSSTEM IMPLANT CO., LTD., Seoul (KR)

(72) Inventors: Kyunha HAN, Seoul (KR); Keunsik CHANG, Seoul (KR)

(21) Appl. No.: 18/726,818

(22) PCT Filed: Dec. 29, 2022
(86) PCT No.: PCT/KR2022/021662

§ 371 Date: Feb. 12, 2025

(30) Foreign Application Priority Data
Jan. 4, 2022 (KR) 10-2022-0000969
Jun. 14, 2022 (KR) 10-2022-0072451

(51) Int. Cl. A61C 1/00

(52) U.S. Cl. CPC A61C 1/0023

(57) ABSTRACT

An embodiment of the present invention provides a foot controller for a dental unit chair and a dental unit chair comprising same, wherein a foot controller for a dental unit chair for controlling a treatment tool provided in the dental unit chair comprises: an air valve for controlling the flow rate of air supplied to the treatment tool; a cam block that is installed under a rod provided in the air valve and has a plurality of inclined surfaces having different inclination angles; a pedal part that is disposed at a position spaced apart from the cam block by a predetermined distance and is capable of being rotated left and right and moved vertically by an external force; and a connecting part that connects the cam block and the pedal part so that the cam block moves in conjunction with the movement of the pedal part.

### TECHNICAL FIELD

The present invention relates to a foot controller for a dental unit chair and a dental unit chair including the same, and more particularly, to a foot controller for a dental unit chair that controls the flow rate of air supplied to a treatment tool and a dental unit chair including the same.

### BACKGROUND ART

Generally, dental treatment is performed in a state in which a patient lies on a dental unit chair.

A dental unit chair may include a lighting device that illuminates the inside of an oral cavity, a doctor table provided with various treatment tools, a monitor arm for supporting a monitor for displaying information on the inside of the oral cavity and a computerized tomography (CT) image as well as a water supply device, a table and a foot controller for convenience of the patient, and the like.

Here, the foot controller is used to control, through his/her foot, instruments that an operator cannot directly manipulate and control manually during treatment. For example, the operator may control the output of various treatment tools, such as a handpiece, provided in the dental unit chair by manipulating the foot controller.

A foot controller of related document 1 (Korean Patent Application Publication No. 10-2022-0000094) previously filed by the present applicant has a problem in that, as an upper surface of a cam block is formed in a constant inclination, in operating a pneumatic handpiece, when a flow rate of air supplied to a handpiece is adjusted, revolutions per minute (RPM) output of the handpiece change non-linearly (with a decreasing inclination), Accordingly, when the handpiece is controlled through a foot controller according to the related art, there is a problem in that the handpiece is not output according to the intention of an operator.

### DISCLOSURE

### Technical Problem

The present invention is directed to providing a foot controller for a dental unit chair that linearly output a pneumatic treatment tool and a dental unit chair including the same.

### Technical Solution

One aspect of the present invention provides a foot controller for a dental unit chair for controlling a treatment tool provided in the dental unit chair, the foot controlling including an air valve that controls a flow rate of air supplied to the treatment tool, a cam block installed below a rod provided in the air valve and having a plurality of inclined surfaces having different inclination angles, a pedal part that is disposed to be spaced a predetermined distance from the cam block and is rotatable in a left-right direction and movable in a vertical direction by an external force, and a connection part that connects the cam block and the pedal part to move the cam block in conjunction with movement of the pedal part.

The flow rate of air in the air valve may be non-linearly adjusted in a process of moving the rod provided in the air valve along the plurality of inclined surfaces having different inclination angles on an upper surface of the cam block.

The air valve may include a valve housing in which a pin accommodating space is formed, an air inlet pipe coupled to the valve housing to communicate with the pin accommodating space, an air outlet pipe provided below the air inlet pipe and coupled to the valve housing to communicate with the pin accommodating space, and a flow rate adjusting pin that is provided inside the pin accommodating space and adjusts an opening or closing amount of the air valve, the flow rate adjusting pin may include an upper pin body portion having an inverted truncated cone shape of which a width of a cross section decreases toward a lower side, a lower pin body portion connected to a lower portion of the upper pin body portion and having a truncated cone shape that is symmetrical to the upper pin body portion by a predetermined distance, and the rod provided below the lower pin body portion, and in a state in which the flow rate adjusting pin is completely open, a narrowest portion of a cross section to which the upper pin body portion and the lower pin body portion are connected may be positioned on a central axis of the air outlet pipe.

When the cam block rotates in the left-right direction according to left-right rotation of the pedal part, the air valve and the cam block may be disposed such that the rod of the air valve is positioned on any one of inclined surface among the plurality of inclined surfaces.

The air valve and the cam block may be disposed such that a distance between the plurality of inclined surfaces and the rod changes due to left-right rotation of the connection part according to the left-right rotation of the pedal part and the rod may be pressed or unpressed due to movement of the connection part according to vertical movement of the pedal part, and the plurality of inclined surfaces may include a first inclined surface having a first inclination angle and a second inclined surface having a second inclination angle that is greater than the first inclination angle and connected to the first inclined surface.

A degree of pressing the rod may change depending on a position at which the pedal part moves downward within a left-right rotation range of the pedal part, and the air valve may adjust an amount of air supplied to the treatment tool according to the degree of pressing the rod.

As the rod gradually moves from the first inclined surface to the second inclined surface and is thus pressed, the flow rate of the air gradually increases.

The foot controller may further include an elastic member that provides a restoring force for returning the pedal part to an original position thereof when the external force disappears after the pedal part moves downward due to the external force, wherein the elastic member may be disposed on the connection part.

The pedal part may be positioned vertically above a base of the cam block.

Another aspect of the present invention provides a dental unit chair including the foot controller for a dental unit chair.

### Advantageous Effects

A foot controller for a dental unit chair and a dental unit chair including the same according to the present invention may have the following effects.

According to the present invention, a cam block controls vertical movement of a rod provided in an air valve to control the supply amount of air supplied to a treatment tool through the air valve. As a plurality of inclined surfaces having different inclination angles are formed on an upper surface of the cam block, the inflow amount of air flowing into the air valve in a process of moving the cam block can increase non-linearly. In this case, as air flows into the air valve through operation of a foot controller for a dental unit chair, the inflow amount of air increases non-linearly in the form of an increasing inclination.

In this way, in the foot controller for the dental unit chair according to the present invention, as non-linear air supply can be performed using a pneumatic treatment tool, revolutions per minute (RPM) of the treatment tool in a process of operating the foot controller may increase linearly. Accordingly, the treatment tool can output according to intention of an operator.

The effects of the present invention are not limited to the above effects and should be understood to include all effects that may be deduced from the detailed description of the present invention or the configuration of the present invention described in the appended claims.

### DESCRIPTION OF DRAWINGS

FIG. 1 is a perspective view of a dental unit chair according to an embodiment of the present invention.

FIG. 2 is a perspective view of a foot controller according to the embodiment of the present invention.

FIG. 3 is a perspective view illustrating an interior of the foot controller according to the embodiment of the present invention.

FIG. 4 is a side view illustrating main parts of the foot controller according to the embodiment of the present invention.

FIG. 5 is a cross-sectional view of an air valve according to the embodiment of the present invention.

FIG. 6 is an exemplary view of a cam block according to the embodiment of the present invention.

FIG. 7 is a view illustrating an operating state of the air valve according to the embodiment of the present invention.

FIG. 8 is an exemplary view illustrating a state in which a pedal part is positioned in the center of a rail according to the embodiment of the present invention.

FIG. 9 is an exemplary view illustrating positions of the cam block and a rod in FIG. 8.

FIG. 10 is an exemplary view illustrating a state in which the pedal part is rotated to a left portion of the rail according to the embodiment of the present invention.

FIG. 11 is an exemplary view illustrating positions of the cam block and the rod in FIG. 10.

FIG. 12 is an exemplary view illustrating a state in which the pedal part is rotated to a right portion of the rail according to the embodiment of the present invention.

FIG. 13 is an exemplary view illustrating positions of the cam block and the rod in FIG. 12.

### MODES OF THE INVENTION

Hereinafter, the present invention will be described with reference to the accompanying drawings. However, the present invention may be implemented in various different forms and thus is not limited to embodiments described herein. Further, in the drawings, parts irrelevant to the description are omitted in order to clearly describe the present invention, and throughout the specification, similar numerals reference numerals are assigned to similar parts.

Throughout the specification, when a first part is connected to a second part, this includes not only a case in which the first part is “directly connected” to the second part but also a case in which the first part is “indirectly connected” to the second part with a third part interposed therebetween. Further, when a part “includes” a component, this means that another component is not excluded but may be further included unless otherwise stated.

In the present invention, an upper side and a lower side mean a state of being positioned above or below a target member and do not necessarily mean a state of positioned above or below the target member with respect to the direction of gravity.

Hereinafter, embodiments of the present invention will be described in detail with reference to the accompanying drawings.

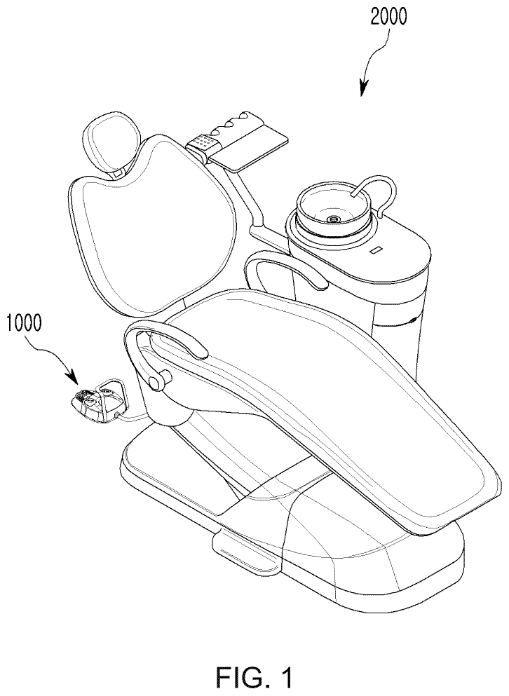

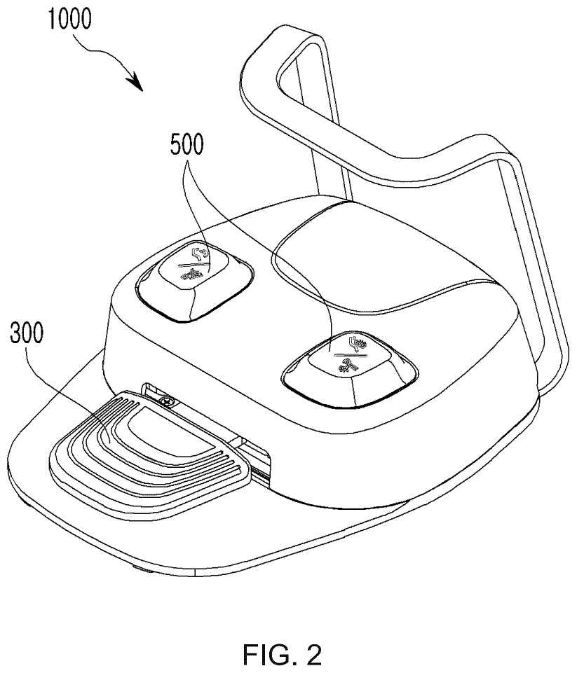

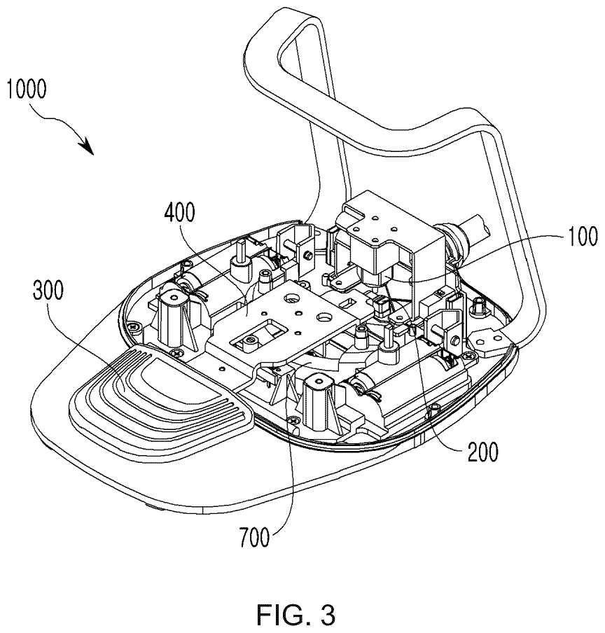

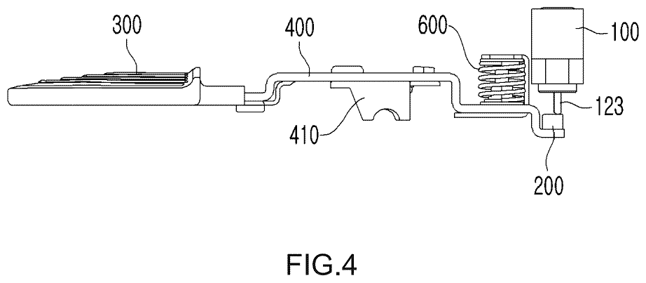

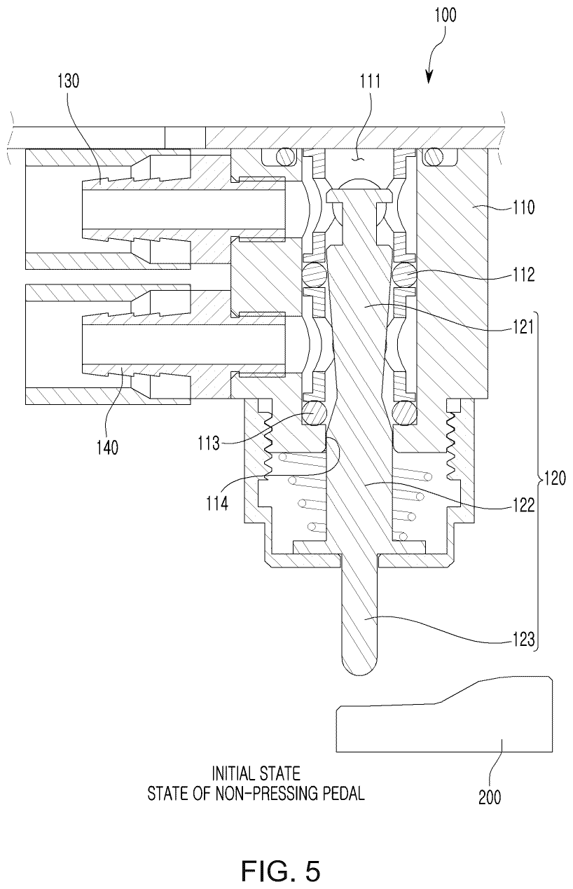

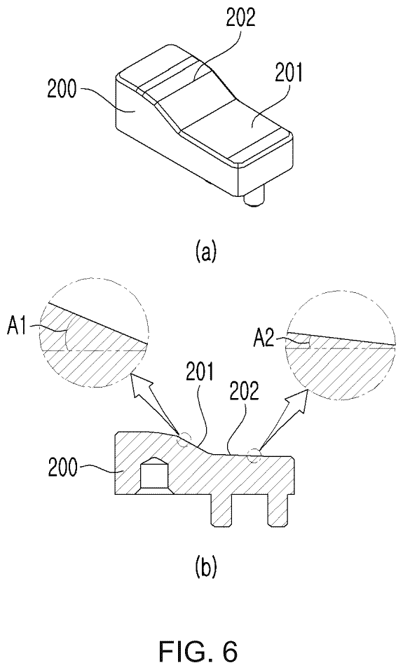

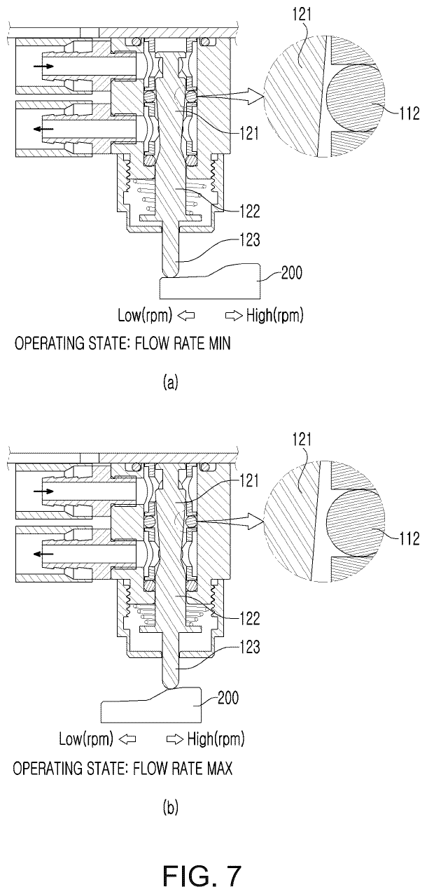

FIG. 1 is a perspective view of a dental unit chair according to an embodiment of the present invention, FIG. 2 is a perspective view of a foot controller according to the embodiment of the present invention, FIG. 3 is a perspective view illustrating an interior of the foot controller according to the embodiment of the present invention, FIG. 4 is a side view illustrating main parts of the foot controller according to the embodiment of the present invention, FIG. 5 is a cross-sectional view of an air valve according to the embodiment of the present invention, FIG. 6 is an exemplary view of a cam block according to the embodiment of the present invention, and FIG. 7 is a view illustrating an operating state of the air valve according to the embodiment of the present invention.

As illustrated in FIG. 1 to 7, the dental unit chair 2000 may basically include a seat on which a leg of a patient is put, a backrest against which a back of the patient leans, and a headrest that supports a head of the patient. An armrest on which an arm of the patient is supported may be formed on a side surface of at least one of the backrest and the seat.

Further, the dental unit chair 2000 may include a base for supporting the seat, a driving unit that drives at least one of the backrest and the seat, and a controller that controls the driving unit.

Further, the dental unit chair 2000 may include at least one of a lighting unit for illuminating the patient, a water supply unit for supplying gargle water for rinsing an oral cavity of the patient, a control unit, a display unit, a foot controller 1000, and a power supply unit.

Further, the dental unit chair 2000 may include a work table. A representative example of the work table may be a doctor table for holding various instruments for dental treatment.

The work table includes various switches, and thus the operator may control each part of the dental unit chair 2000 by manipulating the switches.

Further, the dental unit chair 2000 may be provided with various treatment tools such as a high-speed handpiece, a low-speed handpiece, a three-way syringe, and a scaler.

Meanwhile, the foot controller 1000 is electrically connected to the dental unit chair 2000, and thus the operator may control operations of various instruments included in the dental unit chair 2000 through the foot controller 1000. For example, the operator may control operation of the treatment tool such as a handpiece or adjust an angle of a chair on which the patient sits or lies through the foot controller 1000.

For example, the operator may select an instrument provided in the dental unit chair 2000 through a switch unit 500 included in the foot controller 1000 and control operation of the corresponding instrument through operation of a pedal part 300 provided in the foot controller 1000. Here, in a state in which the pedal part 300 is selectively rotated in a left or right direction, the operator may step on the pedal part 300 to control operation of the corresponding instrument.

In this way, the foot controller, which controls various instruments included in the dental unit chair 2000 through foot manipulation of the operator, may include an air valve 100, a cam block 200, the pedal part 300, and a connection part 400.

The air valve 100 adjusts a flow rate of air supplied to the treatment tool provided in the dental unit chair 2000. That is, the air valve 100 adjusts revolutions per minute (RPM) of the treatment tool (e.g., the handpiece) by adjusting an opening or closing amount.

The opening or closing amount of the air valve 100 may be adjusted depending on a position of the cam block 200. An operation of the air valve 100, of which the opening or closing amount is adjusted by the cam block 200, will be described below.

The air valve 100 may include a valve housing 110, a flow rate adjusting pin 120, an air inlet pipe 130, an air outlet pipe 140, and a sealing part.

A pin accommodating space 111 may be formed inside the valve housing 110, and the flow rate adjusting pin 120 that adjusts the opening or closing amount of the air valve 100 may be disposed inside the pin accommodating space 111. The opening or closing amount of the air valve 100 is adjusted by moving the flow rate adjusting pin 120 in a vertical direction inside the pin accommodating space 111.

The air inlet pipe 130 is coupled to the valve housing 110 and communicates with the pin accommodating space 111.

Like the air inlet pipe 130, the air outlet pipe 140 is coupled to the valve housing 110 and communicates with the pin accommodating space 111.

Meanwhile, the flow rate adjusting pin 120, which adjusts the opening or closing amount of the air valve 100, may include an upper pin body portion 121, a lower pin body portion 122, and a rod 123.

The upper pin body portion 121 may have a truncated cone and has a shape of which a width of a cross section decreases toward a lower side.

The lower pin body portion 122 is provided below the upper pin body portion 121 and is integrated with the upper pin body portion 121. Here, an upper portion of the lower pin body portion 122, which is connected to a lower portion of the upper pin body portion 121, may be formed in a truncated cone shape symmetrical to the upper pin body portion 121. That is, the upper portion of the lower pin body portion 122 may be formed such that a width of a cross section thereof increases as it goes downward by a certain distance.

The rod 123 is coupled to a lower portion of the lower pin body portion 122 and moves in the vertical direction by the cam block 200. Here, the operator presses the pedal part 300 or selectively rotates the pedal part 300 within a rotation radius to adjust the position of the cam block 200 so that the vertical movement of the rod 123 is adjusted. In other words, the air valve 100 may change a flow rate of air supplied to the treatment tool according to a pressing degree to which the rod 123 is pressed by the cam block 200.

Further, the sealing part is provided on an inner surface of the valve housing 110. The sealing part prevents air from leaking out of the valve housing 110 in a state in which the air valve 100 is closed by the flow rate adjusting pin 120.

The sealing part may include a first sealing member 112 and a second sealing member 113. The first sealing member 112 is disposed between the air inlet pipe 130 and the air outlet pipe 140, comes into contact with an outer surface of the upper pin body portion 121 in a state in which the air valve 100 is closed, and thus prevents air from moving from the air inlet pipe 130 to the air outlet pipe 140.

When the air valve 100 is operated in an open state, the second sealing member 113 comes into contact with an outer surface of the lower pin body portion 122 to prevent air from flowing into the valve housing 110 from the outside or prevent air inside the valve housing 110 from flowing to the outside through an insertion hole 114 of the valve housing 110.

In schematically describing an operation process of the air valve 100, the operator adjusts a pressing degree of the rod 123 pressed by the cam block 200 through the rotating and pressing of the pedal part 300. For example, in a state in which the air valve 100 is closed, when the operator steps on the pedal part 300 to move the rod 123 upward, the lower pin body portion 122 and the upper pin body portion 121 integrally coupled with the rod 123 are moved upward together. In this process, the first sealing member 112 in close contact with the upper pin body portion 121 and the upper pin body portion 121 are spaced apart from each other, the air supplied into the valve housing 110 through the air inlet pipe 130 moves to the air outlet pipe 140 through a space between the first sealing member 112 and the upper pin body portion 121, and the air supplied to the air outlet pipe 140 is ultimately supplied to the treatment tool.

Here, as the upper pin body portion 121 has a reverse truncated cone shape, the space between the first sealing member 112 and the upper pin body portion 121 increases as the flow rate adjusting pin 120 is lifted up, and thus an inflow amount of the air may increase.

Further, in a state in which the air valve 100 is completely open, a portion of the flow rate adjusting pin 120 having the smallest width of a cross section thereof to which the upper pin body portion 121 and the lower pin body portion 122 are connected is positioned on a central axis of the air outlet pipe 140. Accordingly, the air discharged from the air inlet pipe 130 to the air outlet pipe 140 may be discharged more effectively.

Meanwhile, the cam block 200 is installed below the rod 123 and selectively presses the rod 123. A plurality of inclined surfaces forming different inclination angles may be formed on an upper surface of the cam block 200. In the present invention, a state in which a first inclined surface 201 forming a first inclination angle A1 and a second inclined surface 202 forming a second inclination angle A2 are formed on the upper surface of the cam block 200 will be described as an example. Here, it is obvious that three or more different inclination angles may be formed on the upper surface of the cam block 200.

It is preferable that the first inclined surface 201 may form the first inclination angle A1 of 1.5° to 2.5°, and it is more preferable that the first inclined surface 201 may form an inclination angle of 2°. As an example, when the dental treatment is performed while the treatment tool is rotated at a low speed, the operator may selectively adjust a height of the rod 123 and adjust the RPM of the treatment tool in a state in which the first inclined surface 201 is positioned below the rod 123.

Further, it is preferable that the second inclined surface 202 may form the second inclination angle A2 of 27° to 31°, and it is more preferable that the second inclined surface 202 may form an inclination angle of 29°. As an example, when the dental treatment is performed while the treatment tool is rotated at a high speed, the operator may selectively adjust the height of the rod 123 and adjust the RPM of the treatment tool in a state in which the second inclined surface 202 is positioned below the rod 123.

In this way, the formation of the first inclined surface 201 and the second inclined surface 202 forming different inclination angles on the upper surface of the cam block 200 is to linearly increase output of the treatment tool when a pneumatic treatment tool is operated.

Due to the nature of the pneumatic treatment tool, when an air flow rate linearly increases through the air valve 100, the RPM of the treatment tool increases non-linearly. In this case, the treatment tool fails to perform the output as intended, and thus the operator cannot properly treat the patient.

In the present invention, the first inclined surface 201 and the second inclined surface 202 having different inclination angles are formed together on the upper surface of the cam block 200 such that the first inclined surface 201 and the second inclined surface 202 are connected to each other. Thus, for example, when the flow rate of the air supplied to the treatment tool through movement of the cam block 200 further increases in a state in which the second inclined surface 202 is positioned below the rod 123, the rod 123 pressed along the second inclined surface 202 non-linearly increases the flow rate of the air, and thus the RPM of the treatment tool may increase linearly. In this way, the foot controller 1000 linearly increases the RPM of the treatment tool in a situation in which the treatment tool is rotated at a high speed. Thus, the handpiece may output according to the intension of the operator.

Meanwhile, the pedal part 300 may be spaced a predetermined distance from the cam block 200 and may rotate in a left-right direction and move in the vertical direction by an external force. For example, the operator may rotate the pedal part 300 in the left-right direction using a foot or may step on the pedal part 300 at a specific position to move the pedal part 300 in the vertical direction.

Here, the connection part 400 may connect the pedal part 300 and the cam block 200, and thus the cam block 200 may move in conjunction with the movement of the pedal part 300 (i.e., the left-right rotation or the vertical movement). Thus, when the pedal part 300 rotates in the left-right direction, the cam block 200 rotates in the left-right direction in conjunction with the left-right rotation, and when the pedal part 300 moves in the vertical direction, the cam block 200 may move in the vertical direction in conjunction with the vertical movement.

Meanwhile, the connection part 400 may be configured such that the pedal part 300 is positioned vertically above the base of the cam block 200, but the present invention is not necessarily limited thereto. For example, in a state in which the pedal part 300 is non-pressed, the pedal part 300 is positioned further away from the ground than the base of the cam block 200. Here, a relative position between the pedal part 300 and the cam block 200 may change depending on a configuration of the connection part 400 (e.g., a shape of the connection part).

The connection part 400 may be made of a metal material with a predetermined thickness to firmly connect the pedal part 300 and the cam block 200, but the present invention is not limited thereto.

Further, the foot controller 1000 may further include an elastic member 600.

The elastic member 600 is configured such that, after a downward movement of the pedal part 300 occurs due to an external force (e.g., when the operator steps on the pedal part), when the external force disappears (e.g., when the operator takes his/her foot off from the pedal part), a restoring force for returning the pedal part 300 to an original position thereof is provided. The elastic member 600 is disposed on the connection part 400 and restores the pedal part 300 to an original position thereof when a force applied to the pedal part 300 is removed.

Meanwhile, the foot controller 1000 may further include a rail 700 that guides the left-right rotation of the pedal part 300. Further, a movable guide 410 is provided at a lower portion of the connection part 400. A groove seated on the rail 700 having a gentle U shape is formed at a lower portion of the movable guide 410, and thus when the operator rotates the pedal part 300 in the left-right direction, the movable guide 410 moves in a longitudinal direction of the rail 700. The movable guide 410 provided in the pedal part 300 moves along the rail 700, and a left-right rotation angle range of the pedal part 300 is determined according to a length of the rail 700.

Meanwhile, when the cam block 200 rotates in the left-right direction due to the left-right rotation of the pedal part 300, an inclined surface formed in the cam block 200 is always positioned at a lower portion of the rod 123 of the air valve 100. That is, the cam block 200 selectively pressing the rod 123 and coupled to one end of the connection part 400 is disposed below the rod 123 to press the rod 123 so that the pedal part 300 rotates in the left-right direction. In this way, the reason why the pedal part 300 is formed to rotate about the cam block 200 is for pressing the rod 123 by moving the cam block upward by the connection part 400 when the operator steps on the pedal part 300 with his/her foot (the pedal part moves downward).

Here, the inclined surface of the cam block 200 disposed below the rod 123 is changed according to the left-right rotation of the pedal part 300, and thus the operator may variously adjust the opening or closing amount of the air valve 100 through the left-right rotation of the pedal part 300. That is, the operator may variously adjust the pressing of the rod 123 through adjusting of a position of the inclined surface of the cam block 200 that presses the rod 123.

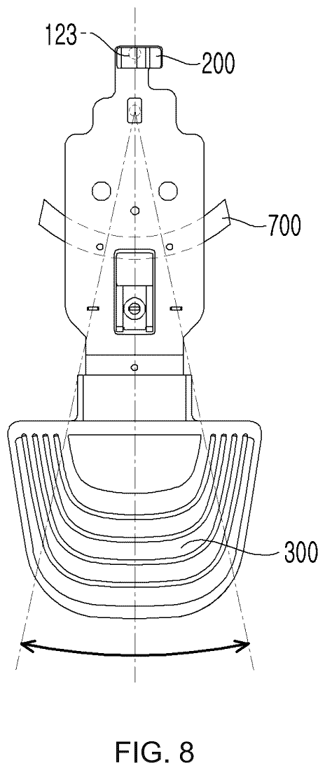

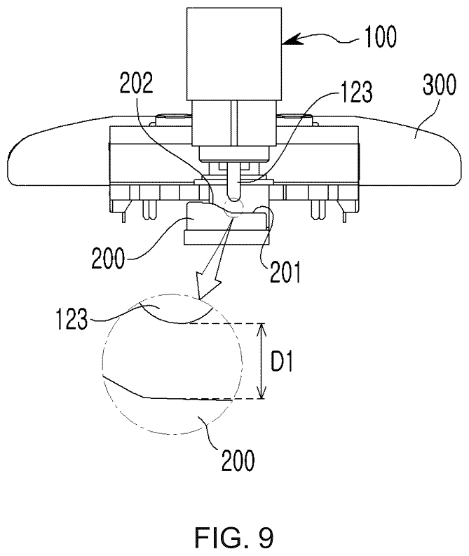

FIG. 8 is an exemplary view illustrating a state in which a pedal part is positioned in the center of a rail according to the embodiment of the present invention, and FIG. 9 is an exemplary view illustrating positions of the cam block and a rod in FIG. 8.

FIGS. 8 and 9 are exemplary views illustrating a state in which the pedal part 300 is positioned in the center of the rail 700. In a state in which the operator does not step on the pedal part 300 with his/her foot, a point at which the first inclined surface 201 and the second inclined surface 202 formed on the upper surface of the cam block 200 meet each other is positioned below the rod 123. In this state, the cam block 200 and the rod 123 are spaced a first distance D1 from each other.

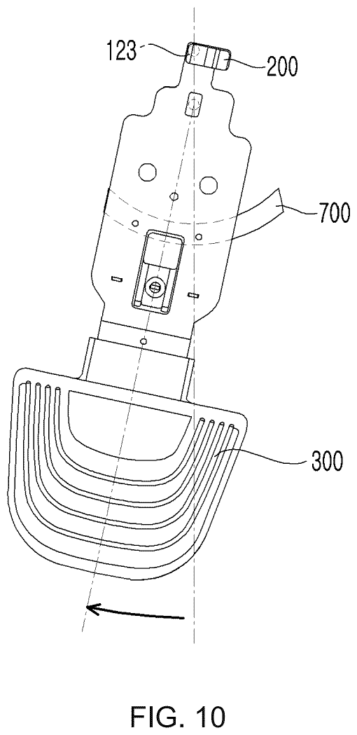

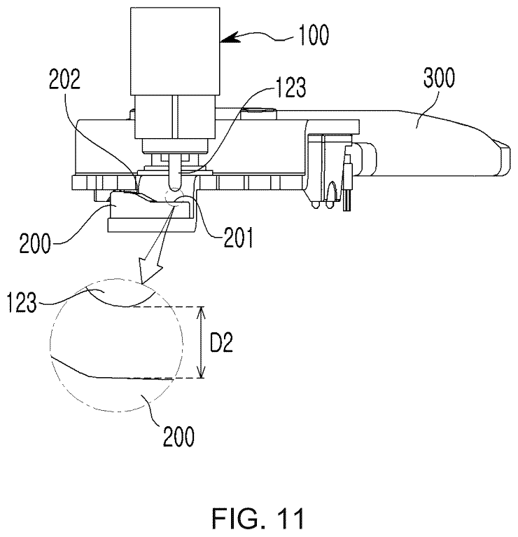

FIG. 10 is an exemplary view illustrating a state in which the pedal part is rotated to a left portion of the rail according to the embodiment of the present invention, and FIG. 11 is an exemplary view illustrating positions of the cam block and the rod in FIG. 10.

FIGS. 10 and 11 are exemplary views illustrating a state in which the pedal part 300 is rotated to the left portion of the rail 700. In a state in which the operator does not step on the pedal part 300 with his/her foot, the first inclined surface 201 formed on the upper surface of the cam block 200 is positioned below the rod 123. In this state, the cam block 200 and the rod 123 are spaced a second distance D2 from each other.

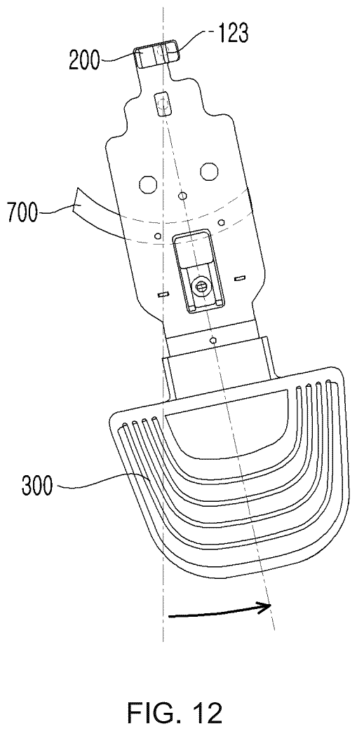

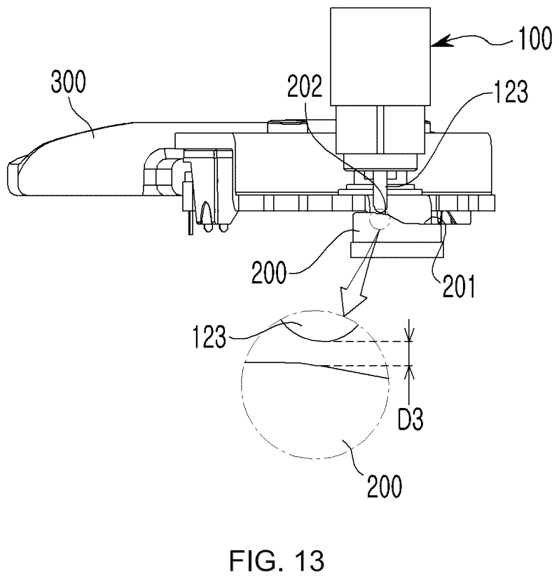

FIG. 12 is an exemplary view illustrating a state in which the pedal part is rotated to a right portion of the rail according to the embodiment of the present invention, and FIG. 13 is an exemplary view illustrating positions of the cam block and the rod in FIG. 12.

FIGS. 12 and 13 are exemplary views illustrating a state in which the pedal part 300 is rotated to the right portion of the rail 700. In a state in which the operator does not step on the pedal part 300 with his/her foot, the second inclined surface 202 formed on the upper surface of the cam block 200 is positioned below the rod 123. In this state, the cam block 200 and the rod 123 are spaced a third distance D3 from each other.

In this way, when the operator rotates the pedal part 300 to a left portion, the rod 123 is positioned on a right portion on which the first inclined surface 201 of the cam block 200 is formed, and when the operator rotates the pedal part 300 to a right portion, the rod 123 is positioned on a left portion on which the second inclined surface 202 of the cam block 200 is formed. Accordingly, among the first distance D1 to the third distance D3, which are the separation distances between the cam block 200 and the rod 123, a value of the second distance D2 is the greatest, and a value of the third distance D3 is the smallest.

Further, as the pedal part 300 is pressed with a foot, the cam block 200 coupled to an end of the connection part 400 moves in the vertical direction to selectively press the rod 123. That is, as the pedal part 300 is pressed, the rod 123 may be selectively pressed or unpressed by the cam block 200.

Here, the degree of pressing the rod 123 may change depending on the left-right rotation of the pedal part 300 and the degree of pressing the pedal part 300. In other words, the air valve 100 may adjust the amount of air supplied to the treatment tool by adjusting the degree of pressing the rod 123 through the left-right rotation of the pedal part 300 and the degree of pressing the pedal part 300.

Meanwhile, a range of the vertical movement of the pedal part 300 may be limited as in the limitation of the range of the left-right rotation of the pedal part 300 as described above.

In schematically describing a process of adjusting the amount of supplied air in the air valve 100 by pressing the rod 123, for example, in a state in which the pedal part 300 is positioned in the center of the rail 700, when the operator completely steps on the pedal part 300, the cam block 200 presses the rod 123 while the first distance D1 is subtracted. Accordingly, the air valve 100 supplies air to the treatment tool according to an open state in which the corresponding rod 123 is pressed.

Further, in a state in which the pedal part 300 is rotated to the left portion of the rail 700, when the operator completely steps on the pedal part 300, the cam block presses the rod 123 while the second distance D2 is subtracted. Accordingly, the air valve 100 supplies air to the treatment tool according to an open state in which the corresponding rod 123 is pressed.

Further, in a state in which the pedal part 300 is rotated to the right portion of the rail 700, when the operator completely steps on the pedal part 300, the cam block presses the rod 123 while the third distance D3 is subtracted. Accordingly, the air valve 100 supplies air to the treatment tool according to an open state in which the corresponding rod 123 is pressed.

For example, in a state in which the operator presses the pedal part 300 with the same intensity, when the operator moves the pedal part 300 from the left portion to the right portion, a position of the inclined surface of the cam block 200 that presses the rod 123 is moved from the first inclined surface 201 to the second inclined surface 202, the pressing of the rod 123 becomes greater, and thus the flow rate of air supplied to the treatment tool increases. Further, the flow rate of air supplied to the treatment tool may be selectively adjusted even through adjusting of a pressing intensity of the pedal part 300.

In this way, the operator may variously adjust the flow rate of air supplied to the treatment tool through the range of the left-right rotation angle of the pedal part 300 and adjusting of the pressing intensity of the pedal part 300.

However, this is merely embodiments of the present invention, and the scope of rights of the present invention is not limited by the scope of the descriptions of the embodiments.

The above description of the present invention is merely illustrative, and those skilled in the art to which the present invention pertains can understand that the present invention can be easily modified in other specific forns without changing the technical spirit or essential features of the present invention. Therefore, it should be understood that the embodiments described above are illustrative but not limiting in all aspects. For example, components described as a single type may be implemented in a distributed manner, and likewise, components described as a distributed manner may also be implemented in a coupled form.

The scope of the present invention is indicated by the appended claims, and all changes or modifications derived from the meaning and scope of the appended claims and equivalent concepts thereof should be construed as being included in the scope of the present invention.

1. A foot controller for a dental unit chair for controlling a treatment tool provided in the dental unit chair, the foot controller comprising:
an air valve configured to control a flow rate of air supplied to the treatment tool;
a cam block installed below a rod provided in the air valve and having a plurality of inclined surfaces having different inclination angles;
a pedal part that is disposed to be spaced a predetermined distance from the cam block and is rotatable in a left-right direction and movable in a vertical direction by an external force; and
a connection part configured to connect the cam block and the pedal part to move the cam block in conjunction with movement of the pedal part.

2. The foot controller of claim 1, wherein the flow rate of air in the air valve is non-linearly adjusted in a process of moving the rod provided in the air valve along the plurality of inclined surfaces having different inclination angles on an upper surface of the cam block.

3. The foot controller of claim 1, wherein the air valve includes:
a valve housing in which a pin accommodating space is formed;
an air inlet pipe coupled to the valve housing to communicate with the pin accommodating space;
an air outlet pipe provided below the air inlet pipe and coupled to the valve housing to communicate with the pin accommodating space; and
a flow rate adjusting pin provided inside the pin accommodating space and configured to adjust an opening or closing amount of the air valve,
the flow rate adjusting pin includes:
an upper pin body portion having an inverted truncated cone shape of which a width of a cross section decreases toward a lower side;
a lower pin body portion connected to a lower portion of the upper pin body portion and having a truncated cone shape that is symmetrical to the upper pin body portion by a predetermined distance; and
the rod provided below the lower pin body portion, and
in a state in which the flow rate adjusting pin is completely open, a narrowest portion of a cross section to which the upper pin body portion and the lower pin body portion are connected is positioned on a central axis of the air outlet pipe.

4. The foot controller of claim 1, wherein, when the cam block rotates in the left-right direction according to left-right rotation of the pedal part, the air valve and the cam block are disposed such that the rod of the air valve is positioned on any one of inclined surface among the plurality of inclined surfaces.

5. The foot controller of claim 1, wherein the air valve and the cam block are disposed such that a distance between the plurality of inclined surfaces and the rod changes due to left-right rotation of the connection part according to left-right rotation of the pedal part and the rod is pressed or unpressed due to movement of the connection part according to vertical movement of the pedal part, and
the plurality of inclined surfaces include a first inclined surface having a first inclination angle and a second inclined surface having a second inclination angle that is greater than the first inclination angle and connected to the first inclined surface.

6. The foot controller of claim 5, wherein a degree of pressing the rod changes depending on a position at which the pedal part moves downward within a left-right rotation range of the pedal part, and the air valve adjusts an amount of air supplied to the treatment tool according to the degree of pressing the rod.

7. The foot controller of claim 6, wherein, as the rod gradually moves from the first inclined surface to the second inclined surface and is thus pressed, the flow rate of the air gradually increases.

8. The foot controller of claim 1, further comprising an elastic member configured to provide a restoring force for returning the pedal part to an original position thereof when the external force disappears after the pedal part moves downward due to the external force,
wherein the elastic member is disposed on the connection part.

9. The foot controller of claim 1, wherein the pedal part is positioned vertically above a base of the cam block.

10. A dental unit chair including the foot controller for a dental unit chair of any one of claims 1 to 9.
